(19) United States
(12) Patent Application Publication
(10) Pub. No.: US 2003/0154040 A1
(43) Pub. Date: Aug. 14, 2003

(54) Process to determine battery storage capacity

(76) Inventors: Eberhard Nann, Soest (DE); Christian Kuper, Brilon (DE)

Correspondence Address: CANTOR COLBURN, LLP, 55 GRIFFIN ROAD SOUTH, BLOOMFIELD, CT, 06002

(21) Appl. No.: 10/259,544

(22) Filed: Sep. 27, 2002

(30) Foreign Application Priority Data
Sep. 28, 2001 (EP) 01123434.1

(51) Int. Cl. G06F 19/00

(52) U.S. Cl. 702/63

(57) ABSTRACT

The present invention concerns a process for the determination of charge capacity in a battery, especially the charge and/or aging status.

The invention has the function of determining charge capacity in a battery, especially the charge and/or aging status without disconnecting the battery from the linked electrical system or without creating given operational phases.

A process according to the invention for the determination of charge capacity (10) in an battery (12) especially the charge and/or aging status whereby at least the battery voltage (14), the battery current (16), and the battery temperature (18) are measured during the predetermined operation of the battery (12) with an electrical system (20) that is connected to the battery (12) and whereby through the electrical system (2) one of several exchangeable operational phases (22, 24, 26, 28, 30, and 32) are used and a calculation specification is selected for the calculation of the charge capacity determined from the measured values (34, 36, and 94) depending on the current operational phase (22, 24, 26, 28, 30, and 32) and calculates the appropriate charge capacity (34, 36, and 94) and updates from the previous operational phase (22, 24, 26, 28, 30, and 32) the determined charge capacity (34, 36, and 94). The electrical system can consist, for example, of the electrical array in an automobile or of an uninterruptible energy supply of a signaling device or such.

In addition, a device (40) is suggested for the performance of the process according to the invention as well as a battery (12) with an indicated temperature sensor (76).

Specific information is generated by the charge capacity (34, 36, and 94) that can be processed by a superior management system.

The present invention concerns a process to determine battery storage capacity, especially charging and/or aging statuses.

State-of-the-art processes are known that are used to determine the charging and aging status or to make decisions, for example, concerning the replacement of batteries. Processes are also known for measuring the acid unit weights of a lead battery in an automobile, which depends on the charge status of the battery in determining its charge status. This process is not applicable, however, to maintenance-free batteries.

Furthermore, the charge status of a battery is determined by measuring the terminal voltage, whereby the measured terminal voltage only represents a measure for the charge status if it has achieved the so-called open circuit voltage. This state, for example, can only be achieved in an automobile start-up battery ten hours after it had been charged. Otherwise, the battery must be de-installed, as the battery discharges a small amount of power (mA).

In order to achieve a test result as quickly as possible, the EP 0 447 928 A1, for example, suggests disconnecting the battery to be measured from all connected electrical systems and connecting it to the appropriate Test Control Unit. The test control unit performs three discharge steps according to a given process whereby the reaction of the battery is measured and compared with the values of a newly charged battery. The aging status is determined from this deviation with the help of the measured charge status.

U.S. Pat. No. 5,281,919, for example, presents a device used to determine the battery parameters in the an automobile, such as, charge status, cold start ability, etc. For this purpose, it is necessary to use a generator that is controlled analogously by microprocessor with which the predetermined operating statuses can be adjusted, and the desired information on its status can be obtained from the reaction of the battery. In addition, this document recommends switching off the battery using the appropriate power switch before each test cycle in order to determine the open circuit voltage.

In general, it is considered a disadvantage if the battery must be disconnected from the linked electrical system before the start of a testing mode, either to connect it to a test control unit or to create a defined status. In addition, the known processes and devices cannot formulate a continuous statement on a sufficiently current status of the battery.

The invention is based on the task of determining storage capacity in batteries, especially the charged and aging status, without having to disconnect the battery from the linked electrical system.

In order to accomplish this task, a process for determining an battery's storage capacity, especially the charge and/or aging status, is suggested whereby at least the battery voltage, the battery power, and the battery temperature, can be measured during the battery's intended operation while it is connected to an electrical system, whereby the electrical system has been adjusted to several exchangeable operational phases and while a calculation specification has been selected for calculating the storage capacity, depending on the actual operation phase, and while the determined charge capacity is updated. The electrical system, could, for example consist of the electrical array in an automobile or of the uninterruptible energy supply of a signaling system or something similar. The measurements take place on a continuous basis during various operational phases. A calculation specification for the calculation of the charge capacity to be determined will be selected that depends on the current operational phase. The appropriate charge capacity will be calculated through a comparison with a saved database.

This results in the advantage that a calculation specification for determining the appropriate charge capacity of the battery can be selected according to the current operational phase through which the appropriate charge capacity can be calculated as an option by using the measurement values. The currently determined charge capacity can replace the previous one or can be used for calculations to achieve a new charge capacity. The individual operational phases of the electrical system can be exchanged randomly. It can also be used to plan the determination of the current operational phase from measured values and to select the appropriate calculation specification for this operational phase automatically. The charge capacity can also be determined several times during one operational phase. The determination of a quantity size can also be performed during at least two operational phases. The process can also be applied beneficially with different battery types, such as lead acid batteries and others.

It is also suggested that at least the last determined charge capacity be saved in a storage unit. The current storage capacity are accessible on a permanent basis in order to receive, for example, additional information such as cold start capability, capacity loss in comparison to new batteries and such within the framework of further processing. It is further suggested that the data from a new battery stored in a storage unit be made available for updating and/or determining storage capacity.

It is further suggested that the measurements take place without time limits and/or in discrete time units. The storage capacity can be beneficially monitored on a continuous basis. The number of measured values, especially those that must be saved, can be reduced by measuring them in discrete time units. Furthermore, the measured values can be measured in discrete values making digital processing possible.

It is further suggested that the battery current and the battery voltage be measured. A charge capacity can be determined, for example, from contemporaneously measured values and the change in this charge capacity can be tracked.

It is also suggested that different storage capacity be determined at different periods. For example, the currently determined charge capacity can be considered simultaneously for the current determination of another charge capacity. In addition, the provision of a currently determined charge capacity can take place at a different time than the provision of another charge capacity. A favorable balancing of the device to determine the storage capacity can be achieved.

In addition, it is suggested that the period in which to determine the charge capacity should depend on the required operational change of phases for that determination. For example, the period for the determination of a charge capacity can correspond with the period of the operational phase. As a benefit, the dynamic statuses in the measured values can be determined and/or considered in the determination of storage capacity.

It is suggested that it would be beneficial if the process were applied with the electrical system of an automobile. The reconnecting, switch-off or switching-over of the battery can be avoided for the determination of storage capacity, as well as the creation of certain operational conditions for the determination of storage capacity, such as within the framework of a test mode. In addition, an integrated information module can show the automobile user that the battery must be exchanged or that the battery should be charged with a determined voltage, and so forth.

It is suggested that the measurements be taken expediently in at least one of the following automobile operational phases: idle condition, forward stroke, start preparation, start, driving, and backward stroke. As an advantage, the operational phases that the automobile uses in any case should be utilized to select the calculation specification for the appropriate charge capacity.

It is further suggested that the determined storage capacity and/or measured values be displayed if so required. The user of an array with an uninterruptible power supply can be informed of the time that can be bridged during the outage of an energy supply, for example, or automobile user can be informed of the charge capacity of the battery or its prognosticated life expectancy.

With the invention, it is also suggested that a device be used for determining the storage capacity according to the above-described process whereby the device is equipped at least at one battery pole with a current measuring device capturing all of the electrical current and a temperature measuring device capturing the battery temperature. As a benefit, the device makes the captured measuring values available for the entire process and determines the storage capacity.

It is also suggested that the device be equipped with a storage unit where at least the last determined storage capacity and those of a new battery can be stored. Thus, the necessary data for determining the appropriate storage capacity can be made available by accessing the data for the storage unit. In addition, the changes in measured values and/or storage capacity can be monitored and appropriate messages can be created.

In order to create messages and determine storage capacity, it is suggested that the device be equipped with an evaluation unit. As a benefit, the evaluation unit can contain a compactly designed microprocessor to perform the requested calculations.

It is also suggested that it be equipped with a display and/or signal unit that displays the messages, measured values, charge capacity or other determined information to the user. The display can be optical, in the form of indicator lights, an alphanumeric display, or something similar, or it can be acoustic with a buzzer, or something similar. Different buzzer signals could have different meanings. The display and/or signal units could be at a remote location, for example, in a central location whereby the charge capacity and measured values can be transmitted via a radio or infrared connection.

In addition, it is suggested that the latest determined charge capacity could be displayed. Thus, the user can see the current state of the battery and/or when boundary limits have been reached.

As a benefit, it is suggested a warning message be given when the battery reaches a critical status. Through a timely warning, the user can avoid an outage of the electrical system through appropriate counter measures, such as charging or exchanging the battery.

It is suggested that a battery be used with the invention along with one of the above-described devices, as well as an energy storage cell with two poles for connecting to an electrical system whereby the battery housing is equipped with a temperature sensor. The temperature-measuring sensor can capture the exact battery temperature whereby the influence from interference sources, such as heat created by the automobile engine, can be greatly avoided.

Moreover, it is suggested that two additional connectors be added for voltage measurements. It would be advantageous if these connectors were directly linked to the appropriate battery electrode plates to avoid the influence of the voltage measurements from the transition resistance at the poles, contacts, and so forth, especially during current flow.

It is further suggested that it be equipped with a current measuring device. It should be housed as close as possible to the battery and not behind the distributor. The current measurements can also take place behind the distributor if every exit has a current measurement device and is connected to a measurement value evaluation unit. The current measurement device can be beneficially placed within the battery housing, protecting it from mechanical stress.

The current measuring device can be installed in or at the battery housing to good advantage, protecting it from mechanical stress.

It is likewise suggested that the battery and the device be linked together or in one piece. The component thus created could be equipped with an interface through which the measured values can be shown at a display and/or signal unit. It is further suggested that the battery's determined charge capacity be made available through the device. As an advantage, a compact component can be created. The status of a stored battery can be checked by connecting it before its use to a display unit.

It is suggested that the charged status be determined using the idle voltage U₀. The charge status can also be determined by a discharge with medium current or by balancing the charge acceptance with a discharge whereby the charge balance is maintained on a continuous basis. These processes, for example, can be combined with each other in order to conduct plausibility checks.

Moreover, it is suggested that the aging status be determined by a high current discharge. For example, according to DIN 43 539, a high current discharge can be realized by creating a discharge current in the battery of approximately half the cold weather test current. Such a high current discharge can also be performed with an automobile using the start process whereby the aging status is determined by evaluating the measured values during the start process.

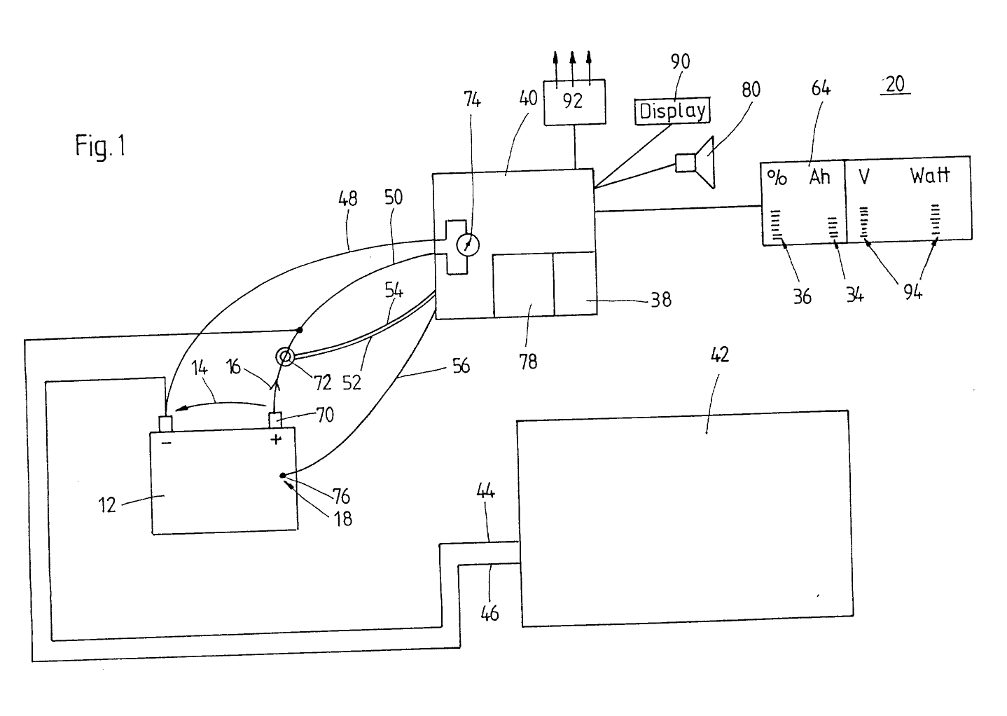

Additional advantages and characteristics can be seen in the following description of the design examples: components remaining essentially the same have the same identification references. In addition, it refers to the description of the design example in FIG. 1 concerning the same characteristics and functions.

They are:

FIG. 1 An electrical system wiring diagram for application in an automobile according to the process

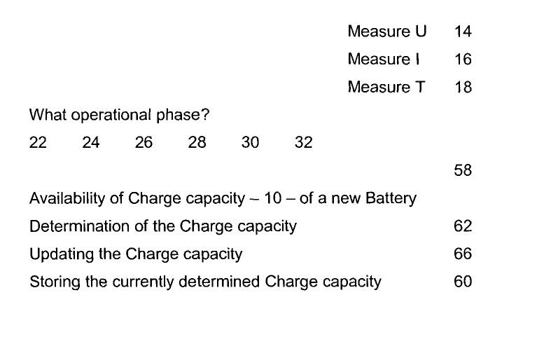

FIG. 2 A flow process diagram according to the invention for the process in an electrical system according to FIG. 1

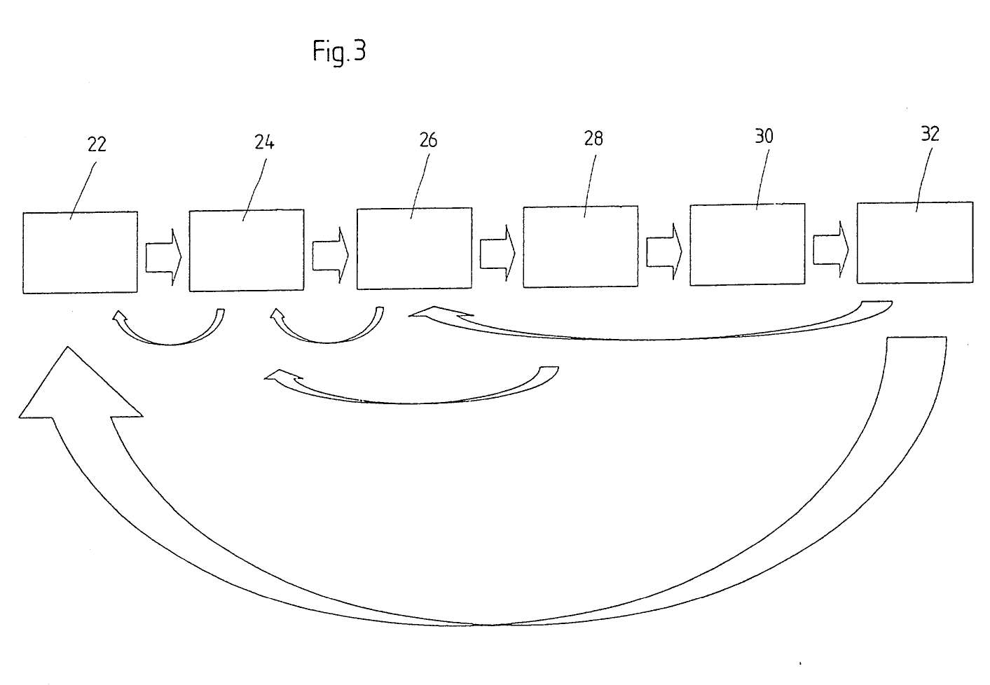

FIG. 3 A diagram of the automobile operational phases

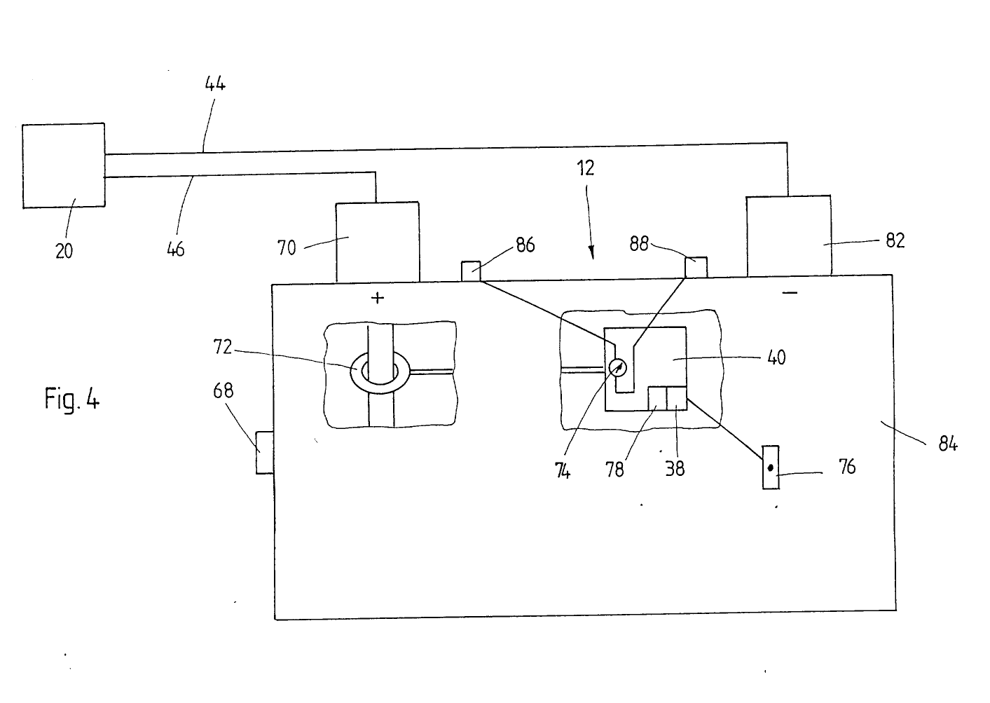

FIG. 4 A battery with a device according to the invention

FIG. 1 shows a wiring diagram for an electrical system 20 with an electric device 42 of an automobile (not shown in detail) that is connected via lines 44, 46 with a battery 12. The device 40 measures the battery voltage 14, the battery current 16 and the battery temperature 18, via the lines 48, 50, 52, 54, and 56.

The device 40 shows the total electrical current 16 at the battery pole 70 through the battery 12 capturing current measuring device 72, a captured voltage measurement device 74 for the battery voltage 14 and the battery temperature 18 captured by the temperature measurement device 76.

The device 40 also contains a storage unit 38 where the latest determined charge capacity 34, 36, and the characteristic values of a new battery 12 can be stored. In addition, there is an evaluation unit 78 for the determination of the charge capacity 34, 36 and an additional charge capacity 94 for capacity to be removed, absorbable charges or limiting temperatures, etc. The current aging status 36 and the current charge status 34, as well as additional charge capacity 94, can be displayed via the display and/or signal unit 64. Once a critical status of the battery 12 has been reached, the buzzer 80 or the display 90 can give a warning message.

FIG. 2 shows a simplified flow process diagram of the process according to the invention to determine the charge status 34, the aging status 36, as well as additional charge capacity 94 of the battery 12, whereby the battery voltage 14, the battery current 16, and the battery temperature 18 are measured during a predetermined operational phase of the battery 12 whereby the battery 12 is connected to the electrical system 20, and whereby the exchangeable operational phases 22, 24, 26, 28, 30, and 32 are measured through the electrical system 20 (FIG. 3) and whereby calculation specifications 58 are selected for the calculation of the charge capacity to be determined from the measured values 34, 36, 94 in dependence upon the current operational phases 22, 24, 26, 28, 30 and 32 and the appropriate charge capacity 34, 36, 94 are calculated and where the previous operational phases 22, 24, 26, 28, 30, and 32 are updated according to the determined charge capacity 34, 36, and 94.

The latest determined charge capacity 34, 36, and 94 are stored in the storage unit 38. For the update and/or determination of the charge capacity 34, 36, and 94, the stored data are available in storage unit 36 of the new battery 12.

Measurement of the battery voltage 14 and the battery current 16 take place simultaneously in a time discreet, as well as a value discreet manner, in order to facilitate processing the measured values, and considering the battery temperature without any time limit.

The charge status 34, the aging status 36, and the additional charge capacity 94, are determined at different times. The periods for the determination of a charge capacity 34, 36, and 94, depend on the operational change phases appropriate for their determination. For example, the aging status 36 can only be determined during the start phase 28 or a high current phase whereby the measured values of the entire start phase are considered in the calculation. The current charge capacity 34, 36, and 94, are stored 60.

FIG. 3 shows the operational phases of an automobile during which the measurements are being taken: idle condition 22, forward stroke 24, start preparation 26, start 28, driving 30, and backstroke 32. The determined charge capacity 34, 36, and 94 are shown on the display unit 64. In addition, arrows display the possible transitions from one operational phase to another.

The determination of operational phases preferably occur automatically, whereby an automobile's signals are evaluated or if a given threshold value is surpassed in the start phase 28 or the battery current 16. The idle condition 22 can occur if a given threshold value falls below of that of the battery current 16.

FIG. 4 shows an battery 12 with a device 40 and an energy storing cell with two poles 70 and 82, connected to the electrical system 20 via lines 44 and 46 whereby a housing 84 of the battery 12 is equipped with a temperature measurement sensor 76.

In addition, two more connectors 86 and 88 are planned for the voltage measurement 14, as well as a current measurement device 72. The connectors 86 and 88 are not connected to poles 70 and 82 of the battery 12 but to the appropriate battery plates, which are not shown in detail. The battery 12 and the device 40 are designed in one piece. The charge capacity 34, 36, and 94, as well as other values are available via interface 68. The communication connection via interface 68 can also be established through radio communication.

Acceptance of the data to determine the aging status only occurs during the operational phase 28, as well as in high current discharges. During the change from operational phase 26 to operational phase 28, the determination takes place when the appropriate calculation specification has been selected. The determination is based on the knowledge that the battery voltage 14 decreases during the battery's 12 loading process with the large battery current 16 as the battery ages. At first, the relevant data are determined for the start. Only measured values are considered where the battery current 16 is larger than 20 percent of the cold weather test current, according to DIN. In addition, the effective idle voltage U₀ is determined depending upon the charge status 34 and the polarization of the battery temperature 18.

With the thus-determined idle condition voltage U₀, the auxiliary variable “internal impedance” Rₓ is calculated using the measured current and voltage quantities.

Rᵢ=(U₀−U_{I})/I_{I}

I=Index of the measured value

Through linear regression via the determined R, the drag curve approaches the straight line. From here, the “internal impedance” Rₓis calculated with a cold weather test current Iₓ. From here, the equivalent start voltage U_{sq} is calculated

with U_{eq}=U₀−Rₖ[illegible]Iₖ

k=cold weather test parameter

This voltage is compared with that of a new battery 12 using a known characteristic and the aging status is determined using a characteristic diagram. Additional tests and steps can be performed, for example, from the plausibility of results. If there is a major deviation from the previous value, which points to a very short remaining life expectancy, a warning signal will be given via the buzzer 80 or the display 90.

To determine the charge status 34 in the idling configuration 22, a sufficient proximity to the equilibrium state of the battery 12 will be used, allowing the calculation from the measured battery voltage 14 under consideration of the idling current. After the charging or discharging phases, for example, in the transition from drive operation 30 to backward stroke 32, the battery voltage 14 does not yet correspond to the equilibrium voltage because concentration gradients and charge polarization effects occur which lift or lower the battery voltage 14. They will be considered through the quantities Δc (or the derived ΔU_{c}) as well as ΔUₚ. These correctional quantities are always included according to given differential equations. Thus, the voltage U₀ can be calculated even outside of the equilibrium status as shown below:

U₀=U−ΔU_{c}−ΔU ₚ

ΔU_{c}=Concentration polarization

ΔUₚ=Charge polarization

In addition, the charge status 34 can be determined with a commissioning of the battery 12 with constant current 16 when the battery voltage 14 follows a charge or discharge characteristic diagram after dismantling of the charge polarization and after adjustment of a stationary concentration gradient, that can be presented analytically and that can be evaluated from the appropriate starting point. The correctional quantities ΔUₚetc., only serve here as an estimate of the proximity of the equilibrium. Should significant deviations occur, the can be used for corrections.

It is also suggested that the charged and discharged loads be carried continuously in addition to the described process for the determination of the charge quantity and to continuously determine the charge status 34. In the charge phases, the charge efficiency is considered and depends on the battery temperature 18, the battery voltage 14, the charge status 34, and the aging status 36.

In this design example, the battery voltage 14 and the battery current 16 are measured simultaneously. It is clear, however, to every specialist that the measurements of these quantities do not have to have a time link. The measurements can be taken, for example, at different times or independent from each other.

The design examples in the figures only serve as an explanation of the invention and are not limited to them. Process steps, calculation specifications and operational phases of the process, as well as the functions and components of the device and of the battery, can vary.

Reference List

| | | | |
|---|---|---|---|
| 10. | Charge capacity | 40. | Evaluation Device |
| 12. | Battery | 42. | Electrical Array in an Automobile |
| 14. | Battery Voltage | 44. | Line |
| 16. | Battery Current | 46. | Line |
| 18. | Battery Temperature | 48. | Line |
| 20. | Electrical System | 50. | Line |
| 22. | Idle Condition | 52. | Line |
| 24. | Forward Stroke | 54. | Line |
| 26. | Start Preparation | 56. | Line |
| 28. | Start | 58. | Calculator Specification |
| 30. | Driving | 60. | Storing |
| 32. | Backward Stroke | 62. | Determination of Charge capacity |
| 34. | Charge Status | 64. | Display Unit |
| 36. | Aging Status | 66. | Quantity Status Updating |
| 38. | Storage Unit | 68. | Interface |
| 70. | Battery Pole | 84. | Housing |
| 72. | Current Measurement Device | 86. | Terminal |
| 74. | Voltage Measurement Device | 88. | Terminal |
| 76. | Temperature Measurement Device | 90. | Display |
| 78. | Evaluation Unit | 92. | Information Module |
| 80. | Buzzer | 94. | Additional Charge capacity |
| 82. | Battery Pole | | |

1. Process for the determination of charge capacity (10) of an battery (12) especially of the charge and/or aging status whereby at least the battery voltage (14), the battery current (16), and the battery temperature (18) are measured during a predetermined operation of the battery (12) in an electrical system (20) that is electrically connected and whereby through the electrical system (20) one or more exchangeable operational phases (22, 24, 26, 28, 30, and 32) are used and a calculator specification is selected for the calculation of the charge capacity to be determined from the measured values (34, 36, and 94) depending upon the current operational phase (22, 24, 26, 28, 30, and 32) and the appropriate charge capacity (34, 36, and 94) is calculated and the charge capacity (34, 36, and 94) that have been determined in an earlier operational phase (22, 24, 26, 28, 30, and 32) are updated accordingly.

2. Process according to claim 1 characterized by the fact that at least the charge capacity determined last (34, 26, and 94) has been saved in a storage unit (38).

3. Process according to claim 1 or 2 characterized by the fact that for the update and/or determination of charge capacity (34, 36, and 94) the saved data of a new battery (12) are available in the storage unit (38).

4. Process according to one of the previous claims characterized by the fact that the measurements are unlimited and/or time discrete.

5. Process according to one of the previous claims characterized by the fact that the measurements of the battery current (16) and the battery voltage (14) take place simultaneously.

6. Process according to one of the previous claims characterized by the fact that different charge capacity (34, 36, and 94) is determined at different time periods.

7. Process according to one of the previous claims characterized by the fact that the period for the determination of a charge capacity (34, 36, and 94) depends on the required operational phase change necessary for the determination.

8. Process according to one of the previous claims characterized by the fact that process is used with an electrical system (20) of an automobile.

9. Process according to claim 8 characterized by the fact that the measurements are taken during at least one of the following operational phases of the automobile: idle condition (22), forward stroke (24), start preparation (26), start (28), driving (30), and backstroke (32).

10. Process according to one of the previous claims characterized by the fact that the determined charge capacity (34, 36, and 94) and/or their measured values are displayed.

11. Process according to one of the previous claims characterized by the fact that the charge status (34) is determined by the idle condition U₀.

12. Process according to one of the previous claims characterized by the fact that the charge capacity (34) is determined by the discharge through a medium current.

13. Process according to one of the previous claims characterized by the fact that the charge status (34) is determined by balancing a charge acceptance and a charge removal.

14. Process according to one of the previous claims characterized by the fact that the aging status (36) is determined by a high current discharge.

15. Process according to one of the previous claims characterized by the fact that the aging status (36) is determined by a start evaluation.

16. Device (40) for the determination of the charge capacity (34, 36, and 94) according to the process and the previous claims characterized by the fact that it includes at least one current measurement device (72) connected to an battery pole (70) capturing the entire electrical current (16) through an battery (12), voltage measurement device (74) capturing the battery voltage (14) and a temperature measurement device (78) capturing the battery temperature (18).

17. Device according to claim 16 characterized by the fact that at least the latest charge capacity (34, 36, and 94) and those of a new battery (12) can be stored in a storage unit (38).

18. Device according to claim 16 or 17 characterized by an evaluation unit (78).

19. Device according to one of the claims 16 to 18 characterized by a display or signal unit (64, 90).

20. Device according to claim 19 characterized by the fact that the latest determined charge capacity (34, 36, and 94) can be displayed.

21. Device according to claims 19 and 20 characterized by the fact that a warning message and/or a signal concerning the charge capacity is given that can be processed by a superior management system (90, 92) once a critical state of the battery (12) has been reached.

22. Battery (12) for the use with a device (40) according to one of the claims 16 to 21 with at least one energy saving cell and with two poles (70, 82) for the connection to an electrical system (20) whereby one housing (84) of the battery (12) is equipped with a temperature measurement sensor (76).

23. Battery (12) according to claim 22 characterized by the fact that two additional connectors (86, 88) are available for a voltage measurement (14).

24. Battery (12) according to claim 22 or 23 characterized by the fact that a current measurement device (72) is available.

25. Battery (12) according to one of the claims 22 to 24 characterized by the fact that the battery (12) and the device (40) are located in one housing.

26. Battery (12) according to claim 25 characterized by the fact that the charge capacity determined by the device (34, 36, and 94) of the battery (12) is made available.
